(19) United States
(12) Patent Application Publication
(10) Pub. No.: US 2026/0243357 A1
(43) Pub. Date: Aug. 20, 2026

(54) FLUID-DISPENSING MOTORISED VALVE

(71) Applicant: VERNET, Ollainville (FR)

(72) Inventors: Guillaume Julien Gautier Graindorge, Montigny Le Bretonneux (FR); Thierry Maraux, Les Clayes Sous Bois (FR)

(21) Appl. No.: 19/159,818

(22) PCT Filed: Feb. 26, 2024
(86) PCT No.: PCT/EP2024/054752

§ 371 Date: Aug. 26, 2025

(30) Foreign Application Priority Data
Feb. 27, 2023 (FR) FR2301790

(51) Int. Cl. F16K 11/085; F16K 31/04

(52) U.S. Cl. CPC F16K 11/0856; F16K 31/043

(57) ABSTRACT

This valve includes a housing that includes a body in plastic material defining an internal volume connected to the outside of the housing by an inlet and outlets, at least one of the outlets including an end. An electric pump, whose intake is connected to the inlet, is arranged in a first sub-volume of the internal volume. A discharge of the pump opens into a passage of the internal volume, connecting the first sub-volume to a second sub-volume. The body defines an opening connecting the second sub-volume to the outside of the body. A plug, fixedly assembled to the body, seals the opening in a fluid-tight manner. A shutter is arranged in the second sub-volume in a movable manner by an electromechanical actuation device to control the opening and closing of the outlets.

### FIELD OF THE DISCLOSURE

The present invention relates to a fluid-dispensing motorized valve.

### BACKGROUND

The valves concerned here include a shutter that is mounted to move, for example, in rotation around an axis.

### SUMMARY

The invention particularly relates to valves for fluid circulation circuits, notably cooling fluid, embedded in vehicles with thermal, electric, hydrogen, or hybrid engines. The fluid flows through the valve by means of its drive in the circulation circuit under the effect of a pump, typically electric. The valves concerned here include a shutter that is mounted to move, for example, in rotation around an axis, in a valve housing, to regulate a fluid flow through the housing between an inlet and outlets of the housing, this shutter being driven in movement by an electromechanical actuation device, integrated into the valve. At each outlet of the housing, a seat device is maintained in sliding sealing contact against the shutter during the movement of the shutter and allows, depending on the position of the shutter, the fluid flow to be selectively let through the seat device, to open the outlet, and prevent the fluid from flowing through the seat device, to close the outlet. In practice, each of these seat devices must be assembled to the housing under constraint, using dedicated fastening and sealing parts, which complicates the assembly of the valve.

The aim of the present invention is to propose a motorized valve whose assembly is more practical and economical.

To this end, the invention relates to a fluid-dispensing motorized valve, as defined in claim 1.

One of the ideas underlying the invention is, on the one hand, to make both a body of the valve housing, inside which the fluid passes through the housing and the shutter is mounted to move, and one or more ends of the housing, which equip respectively the outlets of the housing, in plastic material, and on the other hand, to take advantage of the presence of these plastic parts to assemble them by plastic welding. To do this, each end is assembled to the body of the housing by welding between the body and a plastic part of the end, forming a plastic weld that ensures both the mechanical fixation between the body and the end and the sealing of this fixation. Moreover, this plastic weld is designed, typically by virtue of its dimensions, to withstand, without damage, the mechanical stresses applied to the end by a seat device interposed between the end and the shutter, more precisely by an elastic member of this seat device, which keeps a support member pressed against the end cooperating by sliding contact with the shutter during the movement of the latter. The invention thus allows for dedicated fastening and sealing parts not to be used for the assembly between the body and the ends of the housing, such as screws and added seals, which therefore reduces the cost of components and simplifies the assembly process of the valve according to the invention. Some aspects of the seat devices and the ends can advantageously be provided to gain even more benefits in terms of practicality and/or performance, as detailed below. Furthermore, also as explained in more detail below, the use of plastic welding is advantageously extended to other parts of the housing to further simplify the assembly process of the valve according to the invention. Finally, as detailed below, the invention is advantageously applicable in the case where the valve according to the invention integrates a fluid drive pump and thus forms a module wherein the pump and the shutter are received in the same housing; however, the invention is also applicable in the case where such a pump is separate from the valve, the pump discharge being then connected by a hose or similar to the inlet of the valve housing, whose internal volume mainly receives only the shutter.

Additional advantageous features of the valve according to the invention are defined in the other claims.

### BRIEF DESCRIPTION OF THE DRAWINGS

The invention will be better understood by reading the following description, given solely by way of example and referring to the drawings wherein:

FIG. 1 is a perspective view of a valve according to the invention;

FIG. 2 is a perspective view according to arrow II of FIG. 1;

FIG. 3 is a section according to plane III of FIG. 1;

FIG. 4 is a section according to line IV-IV of FIG. 3, after removal of a cover of the valve;

FIG. 5 is an elevation view according to arrow V of FIG. 4;

FIG. 6 is a larger scale view of the detail circled VI in FIG. 3;

FIG. 7 is a larger scale view of the detail circled VII in FIG. 3; and

FIG. 8 is a larger scale view of the detail circled VIII in FIG. 3.

### DETAILED DESCRIPTION

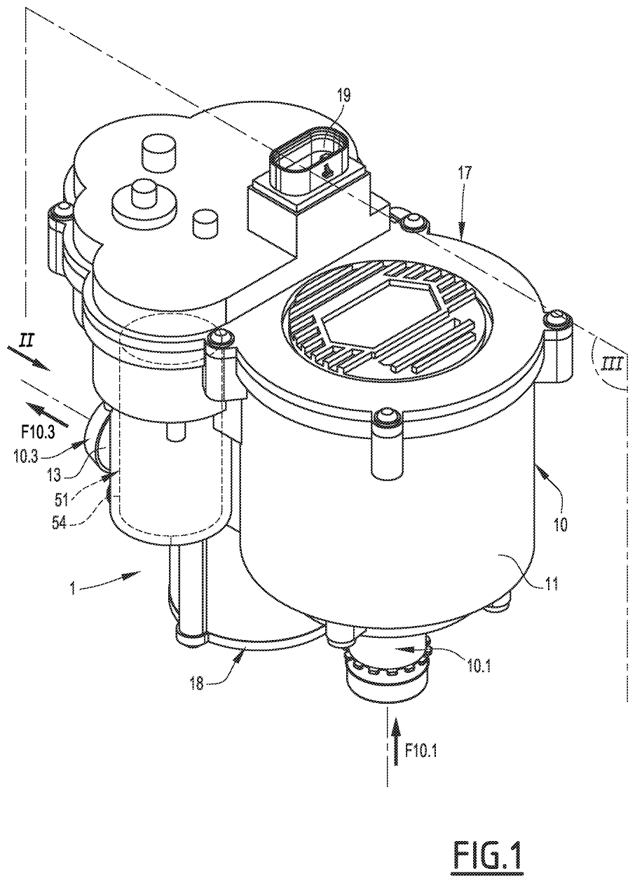

FIGS. 1 to 8 show a fluid-dispensing motorized valve, referenced 1. This valve 1 is suitable for integration into a fluid circulation circuit, notably a cooling fluid. The valve 1 is, for example, used in a cooling circuit of a vehicle engine, this engine being thermal, electric, hydrogen, or hybrid.

The valve 1 includes a housing 10 through which the fluid to be distributed, in other words to be regulated, by the valve 1 is intended to flow. To this end, as clearly visible in FIGS. 1 to 4, the housing 10 includes a body 11, which defines an internal volume V11 through which the fluid passes through the housing 10, as well as an inlet 10.1 and outlets, here four in number and respectively referenced 10.2, 10.3, 10.4, and 10.5. The inlet 10.1 can communicate with the outlets 10.2 to 10.5 through the body 11 via the internal volume V11 of the latter, the effective communication between the inlet 10.1 and one or more of the outlets 10.2 to 10.5 being operated by components of the valve, as detailed below. In service, the fluid enters the internal volume V11 through the inlet 10.1, as schematically indicated by arrow F10.1 in the figures, and the fluid exits the internal volume V11 through the outlets 10.2 to 10.5, as schematically indicated in the figures by the respective arrows F10.2, F10.3, F10.4, and F10.5.

The body 11 is made in one piece of plastic material, preferably molded. The nature of the plastic material constituting the body 11 is not limiting as long as this plastic material, preferably moldable, gives the body 11 sufficient rigidity to delimit the internal volume V11 fixedly. Examples for this plastic material are polyphenylene sulfide, polyphthalamide, and polyamide 6-6. In practice, this plastic material is optionally filled.

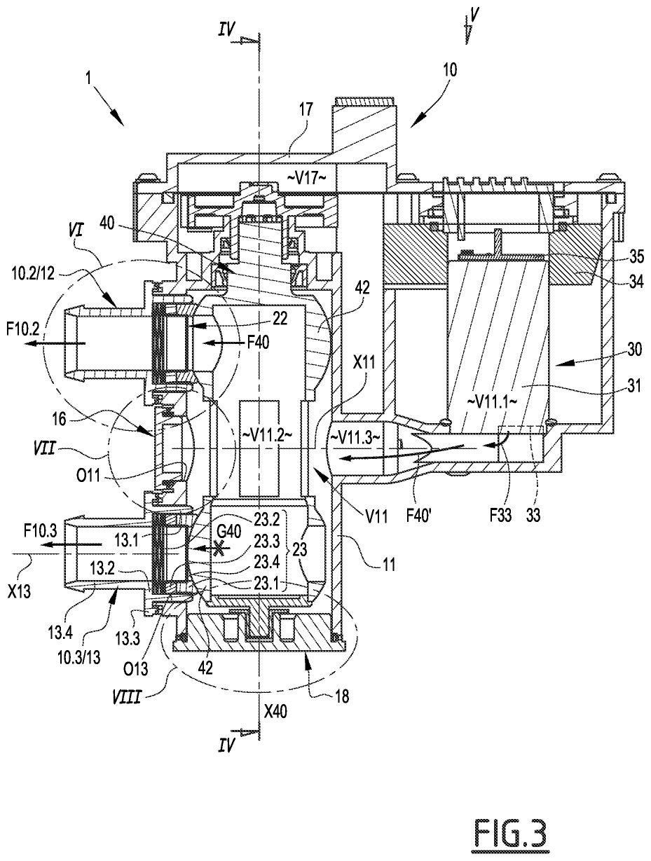

In the embodiment considered in the figures, and for reasons that will appear later, the internal volume V11 of the body 11 is, as clearly visible in FIG. 3, distributed between:
a sub-volume V11.1 wherein the inlet 10.1 opens,
a sub-volume V11.2 wherein the outlets 10.2 to 10.5 open, and
a passage V11.3, which directly connects the sub-volumes V11.1 and V11.2 and which opens into the sub-volume V11.2 along a passage axis X11, or even extends along this passage axis X11 over its entire extent between its ends opening respectively into the sub-volume V11.1 and into the sub-volume V11.2.

Moreover, also in the embodiment considered in the figures, the body 11 defines an opening O11 through which the sub-volume V11.2 is directly connected to the outside of the body 11. The opening O11 is formed by molding-demolding of the body 11, in the sense that the opening O11 results from the use, during the molding of the body 11, of a molding pin, which extends along the passage axis X11 and around which a part of the plastic material constituting the body 11 is molded, to form the passage V11.3. In practice, this molding pin is advantageously used in conjunction with a mold to manufacture the body 11 by molding. More precisely, in order to manufacture the body 11 as shown in the figures, it is notably possible to provide that plastic material is introduced, typically injected, into the aforementioned mold to form the body 11 by molding, while the aforementioned molding pin is arranged in this mold extending along the passage axis X11, so that this plastic material introduced into the mold spreads there until it surrounds the molding pin and thus forms both the peripheral wall of the passage V11.3 and the peripheral wall of the opening O11. To release the body 11 at the end of its molding thus carried out, the aforementioned mold and molding pin are respectively disengaged: to do this, the molding pin is, for example, extracted from the mold before opening the latter, by pulling this molding pin along the passage axis X11 to gradually remove it from the internal volume V11 via the opening O11. In any case, at the end of the demolding of the body 11, the latter delimits, in one piece, the passage V11.3 and the opening O11, which are aligned with each other along the passage axis X11, while being separated from each other by the sub-volume V11.2, as clearly visible in FIG. 3.

In addition to the opening O11, the body 11 defines openings O12, O13, O14, and O15, which, like the opening O11, each directly connect the sub-volume V11.2 to the outside of the body 11, but which, unlike the opening O11, are respectively associated with the outlets 10.2, 10.3, 10.4, and 10.5, as explained a little further. In practice, each of the openings O12, O13, O14, and O15 is typically formed by molding-demolding of the body 11.

The inlet 10.1 of the housing 10 is, in the embodiment considered in the figures, molded with the body 11. That said, in an unshown variant, it may be otherwise.

As for the outlets 10.2 to 10.5 of the housing 10, these outlets are respectively parts that are distinct from the body 11 and fixedly attached in a sealed manner to the latter. More precisely, each of the outlets 10.2 to 10.5 includes an end, respectively referenced 12 to 15, which is assembled to the body 11 in a fixed and sealed manner.

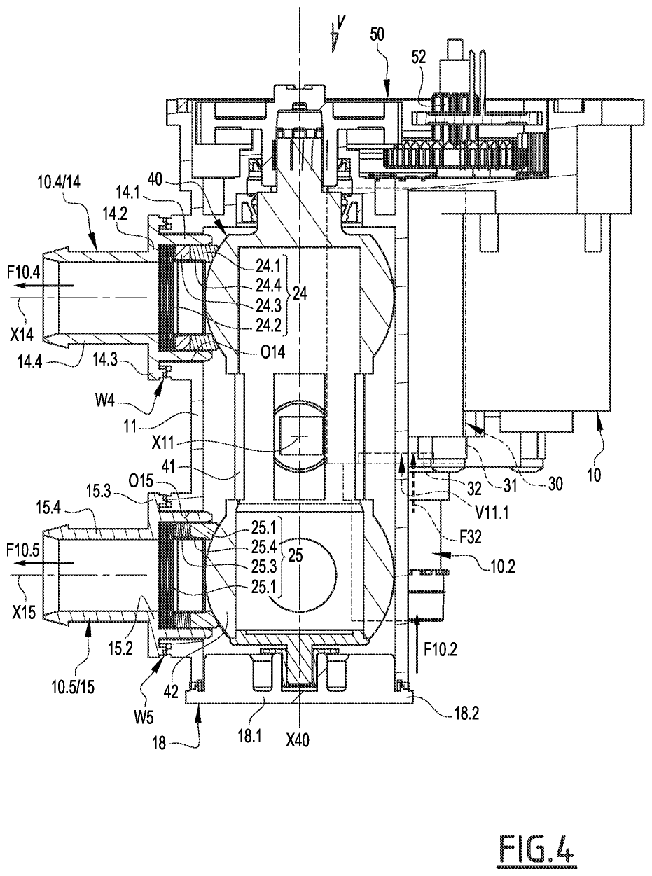

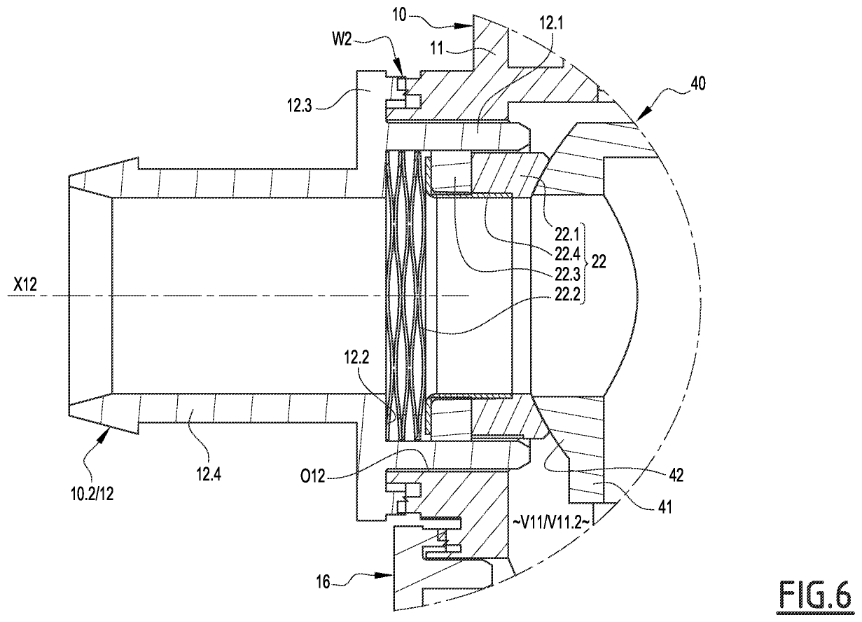

To this end, in the embodiment considered in the figures, and as particularly visible in FIG. 6 for the end 12, each of the ends 12 to 15 includes a tubular skirt 12.1, 13.1, 14.1, 15.1, which is centered on an axis X12, X13, X14, X15 along which this tubular skirt extends in length. In the assembled state of the housing 10, the respective tubular skirts 12.1 to 15.1 of the ends 12 to 15 are axially received in a complementary manner in, respectively, the openings O12 to O15 of the body 11. In other words, the ends 12 to 15 are mounted on the body 11 by coaxial and complementary engagement of their tubular skirt 12.1 to 15.1 in the respective openings O12 to O15 of the body 11, as clearly visible in FIGS. 3 and 4. For reasons that will appear later, each of the tubular skirts 12.1 to 15.1 is internally shouldered, forming an internal shoulder 12.2, 13.2, 14.2, 15.2, i.e., protruding from the internal face of the tubular skirt, this internal shoulder being located at a distance, along the corresponding axis X12, X13, X14, X15 from the axial end of the tubular skirt, turned towards the sub-volume V11.2.

Moreover, each of the ends 12 to 15 includes a peripheral rim 12.3, 13.3, 14.3, 15.3, which externally surrounds the corresponding tubular skirt 12.1 to 15.1. Each of the peripheral rims 12.3 to 15.3 extends in protrusion from the external face of the corresponding tubular skirt 12.1 to 15.1, running all around the corresponding axis X12 to X15. These peripheral rims 12.3 to 15.3 are made of plastic material, in particular the same plastic material as that constituting the body 11. In practice, the tubular skirts 12.1 to 15.1 are also made of plastic material and are formed as solid parts, notably by molding, with the corresponding peripheral rims 12.3 to 15.3, as in the example illustrated in the figures. In any case, in the assembled state of the housing 10, each of the peripheral rims 12.3 to 15.3 is welded to the body 11, more precisely to the external face of the wall of the latter, surrounding the corresponding opening O11 to O15, and this is in such a way as to assemble the corresponding end 12 to 15 to the body 11 in a fixed and sealed manner. The welding between the body 11 and the peripheral rims 12.3 to 15.3 forms respective plastic welds W2, W3, W4, and W5, as schematically indicated in FIGS. 3, 4, and 6: the specifics of these plastic welds W2 to W5 are not limiting as long as these plastic welds W2 to W5 ensure the fixed and sealed bonding between the body 11 and the respective ends 12 to 15. In this regard, each of the plastic welds W2 to W5 advantageously runs continuously all around the corresponding axis X12 to X15. In practice, multiple plastic welding techniques can be used, for example, vibration and/or ultrasonic welding, advantageously without needing to consider the relative orientation around the corresponding axis X12 to X15 between the body 11 and the peripheral rims 12.3 to 15.3. As particularly visible in FIG. 6, each of the plastic welds W2 to W5 is advantageously made by welding together plastic material reliefs, which respectively belong to the body 11 and the corresponding peripheral rim 12.3 to 15.3 and which are associated with recesses wherein the plastic material in the heated state during the welding proper spreads in a retained manner.

Axially opposite their tubular skirt 12.1 to 15.1, each of the ends 12 to 15 advantageously includes a connecting part 12.4 to 15.4 around which a conduit (not shown), such as a hose, which is externally attached to the valve 1, is easily connected. The specifics of these connecting parts 12.4 to 15.4 are not limiting, with multiple embodiments being conceivable. In the example illustrated in the figures, each of the connecting parts 12.4 to 15.4 forms a tube, which is centered on the corresponding axis X12 to X15, being here rectilinear but which in an unshown variant can be bent, and which is advantageously molded with the rest of the end 12 to 15.

More generally, other embodiments than the one detailed above are conceivable for the ends 12 to 15 as long as a plastic part of each end, such as the respective peripheral rims 12.3 to 15.3 of the ends 12 to 15, is welded to the body 11, forming a corresponding plastic weld, such as the plastic welds V2 to V5, in such a way as to assemble each end 12 to 15 to the body 11 in a fixed and sealed manner.

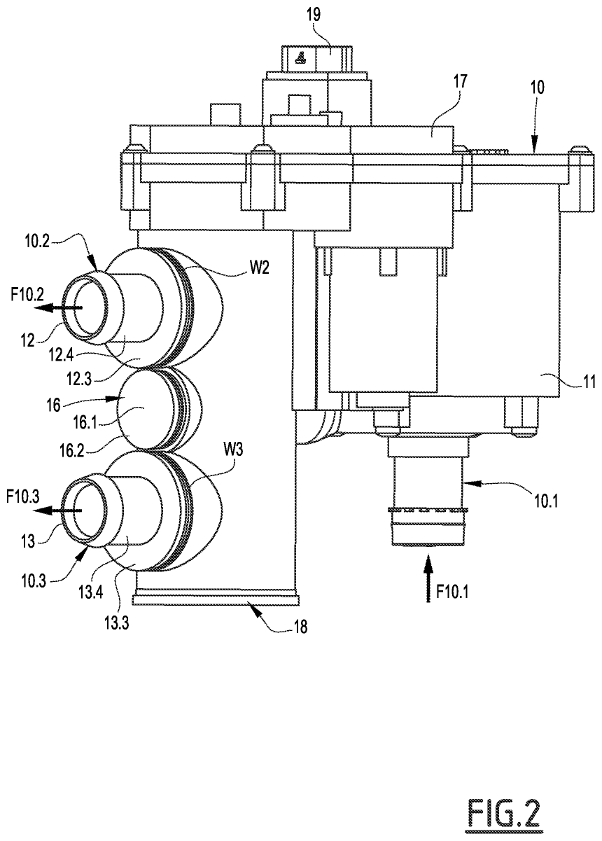

Moreover, as clearly visible in FIGS. 2, 3, and 7, the housing 10 includes a plug 16 which, in the assembled state of the valve 1, seals the opening O11 in a fluid-tight manner with respect to the fluid regulated by the valve 1. In other words, the plug 16 completely closes the opening O11, normally preventing any fluid flow through this opening.

In the embodiment considered here, the plug 16 includes a solid wall 16.1, which, in the assembled state of the valve 1, completely covers the opening O11, being arranged transversely, or even perpendicularly to the passage axis X11, and which, at the outer periphery, is extended by a rim 16.2. This rim 16.2 is made of plastic material, in particular the same plastic material as that constituting the body 11 of the housing 10: for the purposes of the sealed assembly of the plug 16 to the body 11, the rim 16.2 is welded to the body 11, more precisely to the external face of the wall of the latter, surrounding the opening O11. In practice, the technical considerations detailed above regarding the plastic welding of the ends 12 to 15 to the body 11 apply correspondingly to the welding of the plug 16 to the body 11.

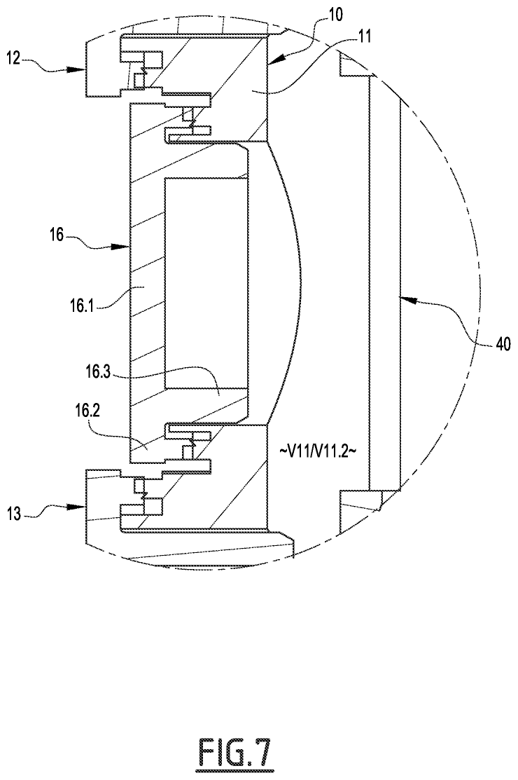

The plug 16 here advantageously includes a skirt 16.3, which extends in protrusion from the solid wall 16.1 and which, in the assembled state of the valve 1, is received coaxially and complementarily in the opening O11, as clearly visible in FIG. 7.

In practice, the plug 16 is advantageously made in one piece, in plastic material. Thus, the solid wall 16.1 and the skirt 16.3 are advantageously molded with the rim 16.2 of the plug 16.

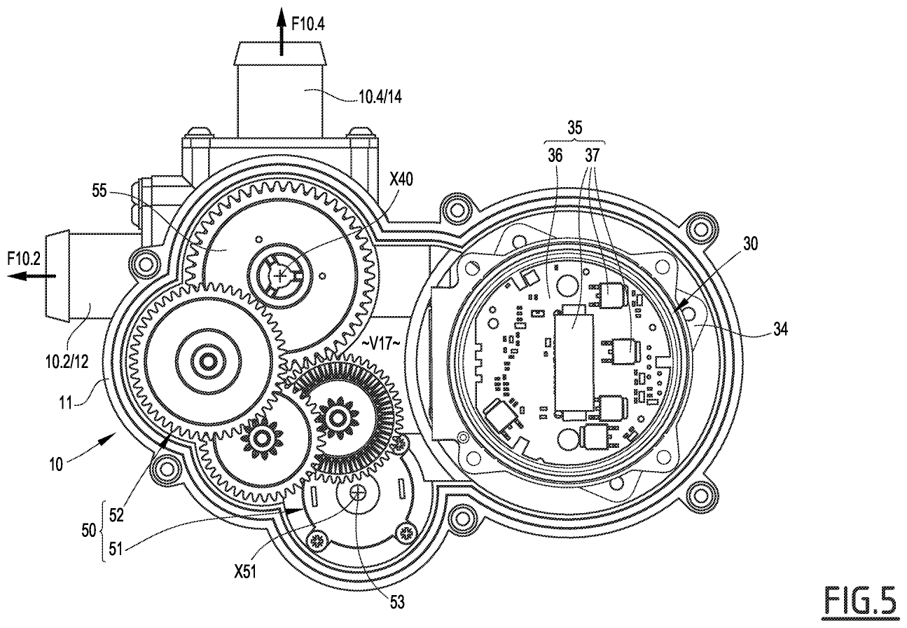

Moreover, in the embodiment considered in the figures, the housing 10 further includes a cover 17 which, in the assembled state of the valve 1, is fixedly attached to the body 11, as clearly visible in FIGS. 1 to 3. In FIGS. 4 and 5, the cover 17 does not appear since the valve 1 is shown there without this cover. This cover 17 and the body 11 delimit between them a compartment V17 which, in the assembled state of the valve 1, is sealed from the internal volume V11, thus forming an internal region of the housing 10, which is sealed with respect to the fluid circulating through the valve 1 via the internal volume V11. To this end, the cover 17 is fixedly sealed to the body 11, and this is achieved by any appropriate means, notably by removable fastening means to facilitate the assembly and maintenance of components of the valve 1 placed inside the compartment V17, such components being detailed below.

In the embodiment considered in the figures, the valve 1 includes, inside the housing 10, a pump 30 allowing the aforementioned fluid to be driven through the housing 10 via the internal volume V11. This pump 30 includes a hydraulic part 31 whose embodiment is not limiting as long as this hydraulic part 31 acts on the fluid to drive it through the housing 10 via the internal volume V11. This hydraulic part 31 of the pump 30 is provided with an intake 32, i.e., an orifice through which the fluid to be pumped by the pump 30 flows into the interior of this hydraulic part 31 and thus enters the hydraulic part 31, and a discharge 33, i.e., an orifice through which the fluid pumped by the pump 30 flows out of the hydraulic part 31 and thus exits this hydraulic part 31. In the assembled state of the valve 1, the hydraulic part 31 of the pump 30 is carried by the body 11 of the housing 10, being arranged in the sub-volume V 11.1 so that, on the one hand, the intake 32 opens into the inlet 10.1 of the housing 10 so that all the fluid entering the internal volume V11, via the inlet 10.1, is directly admitted into the hydraulic part 31, as schematically indicated by arrow F32 in FIG. 4, and, on the other hand, the discharge 33 opens into the passage V11.3 so that all the fluid discharged by the hydraulic part 31 is directly sent into the entrance of this passage V11.3, as schematically indicated by arrow F33 in FIG. 3. In practice, the hydraulic part 31 is assembled to the housing 10 with the interposition of sealing joints, which respectively form ad hoc sealing lines at the intake 32 and the discharge 33. Moreover, in the embodiment considered in the figures, the pump 30 helps to delimit, jointly with the body 11 and the cover 17, the compartment V17 and includes for this purpose a flange 34 or similar, through which a casing of the hydraulic part 31 is fixedly attached to the body 11 and on which the cover 17 is mounted in a sealed manner.

In any case, the pump 30 is electric, in the sense that its hydraulic part 31 is actuated by an electric motor, integrated into the pump. In practice, multiple embodiments are conceivable for this electric motor and for its integration into the rest of the pump 30, without this aspect of the pump being limiting. In any case, the pump 30 includes an electronic part 35, which controls the hydraulic part 31 by driving the electric motor of the pump 30. In the embodiment considered in the figures, the electronic part 35 includes a printed circuit board 36, which is here fixedly carried by the casing of the hydraulic part 31, and various electronic components 37, which are mounted on the printed circuit board 36 and which are designed to control the electric motor of the pump 30, by sending to the latter electrical power and control signals. The functional and structural specifics of the electronic part 35 are not limiting, and they will not be detailed further here. In the assembled state of the valve 1, the electronic part 35 is housed inside the compartment V17, as clearly visible in FIGS. 3 and 5.

The valve 1 further includes a shutter 40, which is carried by the housing 10, being arranged in the internal volume V11, more precisely, here, in the sub-volume V11.2, and being movable relative to the housing 10, here in rotation around a shutter axis X40 relative to which the axes X12 to X15 of the ends 12 to 15 each extend transversely, or even perpendicularly. The shutter 40 allows, by its mobility, here in rotation around the shutter axis X40, to regulate the flow of fluid through the housing 10 by controlling the opening and closing of the outlets 10.2 to 10.5 of the housing 10. In the assembled state of the valve 1, the shutter 40 cooperates by sliding sealing contact with seat devices 22, 23, 24, and 25, which are respectively associated with the outlets 10.2 to 10.5 and which are carried by the housing 10, so that, for each of the seat devices 22 to 25, the shutter 40 is designed, depending on the position of the latter relative to the housing 10, here around the shutter axis X40, to:
either control in the open position the outlet 10.2 to 10.5 associated with the seat device 22 to 25, by letting the fluid flow through the seat device from the sub-volume V11.2 to the end 12 to 15 of this outlet, as schematically illustrated by arrow F40 in FIG. 3 for the outlet 10.2,
or control in the closed position the outlet 10.2 to 10.5 associated with the seat device 22 to 25, by preventing the fluid from reaching the end 12 to 15 of this outlet from the sub-volume V11.2 through the seat device, as illustrated by the barred arrow G40 in FIG. 3 for the outlet 10.3.

Moreover, at least in each of the positions of the shutter 40 relative to the housing 10, here around the shutter axis X40, which control the opening of at least one of the outlets 10.2 to 10.5, the shutter 40 lets the fluid enter the sub-volume V 11.2 from the passage V11.3, as schematically indicated by arrow F40′ in FIG. 3.

Thus, more globally, the shutter 40 allows the fluid entering the internal volume V11 of the body 11 of the housing 10 to be distributed selectively into one or more of the outlets 10.2 to 10.5 of the housing.

In the embodiment considered in the figures, the shutter 40 advantageously includes a generally tubular body 41, which is centered on the shutter axis X40. For reasons that will appear later, the tubular body 41 fixedly carries, on its outer lateral face, spherical reliefs 42, which are centered on the shutter axis X40 and which are distributed so that, during the movement of the shutter around the shutter axis X40, each of the spherical reliefs 42 cooperates, by complementarity of shapes, with one or more of the seat devices 22 to 25 to control in the open and closed position the outlets 10.2 to 10.5. Of course, other embodiments than the one detailed above are conceivable for the shutter 40, such as a paddle shutter.

Whatever the embodiment of the shutter 40, each of the seat devices 22 to 25 is interposed between the shutter 40 and the end 12 to 15 of the outlet 10.2 to 10.5 associated with the seat device, and this is positioned along a seat axis, which here coincides with the axis X12 to X15 of the corresponding end. Following an advantageous arrangement that facilitates the assembly of the seat devices 22 to 25, each of the seat devices is received inside the tubular skirt 12.1 to 15.1 of the corresponding end 12 to 15, as clearly visible in FIGS. 3, 4, and 6.

Each of the seat devices 22 to 25 includes, along the corresponding axis X12 to X15 and moving away from the shutter 40, a support member 22.1, 23.1, 24.1, 25.1, and an elastic member 22.2, 23.2, 24.2, 25.2. Advantageously, each of the seat devices 22 to 25 here also includes a sealing member 22.3, 23.3, 24.3, 25.3, which is interposed along the corresponding axis X12 to X15 between the support member 22.1 to 25.1 and the elastic member 22.2 to 25.2.

The support member 22.1 to 25.1 of each of the seat devices 22 to 25 is mounted to move along the corresponding axis X12 to X15 relative to the corresponding end 12 to 15. On its axial side turned towards the shutter 40, the support member 22.1 to 25.1 cooperates by sliding sealing contact with the shutter 40 during the movement of the shutter 40 relative to the body 10, here in rotation around the shutter axis X40. To this end, the support member 22.1 to 25.1 is provided with a sliding contact surface, which is complementary to the shutter 40, here complementary to one of the spherical reliefs 42. This sliding contact surface is typically made of a non-stick material, such as a plastic material based on polytetrafluoroethylene. In the embodiment considered in the figures, the support member 22.1 to 25.1 advantageously has a generally annular shape, which is centered on the corresponding axis X12 to X15 and whose axial end edge carries the aforementioned sliding contact surface.

The elastic member 22.2 to 25.2 of each of the seat devices 22 to 25 is mounted taking support against the corresponding end 12 to 15 in such a way as to keep the support member 22.1 to 25.1 applied against the shutter 40 along the corresponding axis X12 to X15 during the movement of the shutter 40 relative to the body 10, here in rotation around the shutter axis X40.

In the embodiment considered here, the elastic member 22.2 to 25.2 takes support, on one axial side, against the internal shoulder 12.2 to 15.2 of the tubular skirt 12.1 to 15.1 of the corresponding end 12 to 15 and, on the opposite axial side, against the corresponding sealing member 22.3 to 25.3, here with the interposition of a positioning ring 22.4 to 25.4 of the concerned seat device 22 to 25, the significance of which will become clear later on. As an example, the elastic member 22.2 to 25.2 is a wave spring, also called a zigzag spring, centered on the corresponding axis X12 to X15; in an unshown variant, other embodiments are conceivable for the elastic member 22.2 to 25.2. In any case, the elastic member 22.2 to 25.2 applies mechanical stresses on the corresponding end 12 to 15, here on the internal shoulder 12.2 to 15.2 of the corresponding tubular skirt 12.1 to 15.1, which tend to separate the corresponding end 12 to 15 from the body 11, particularly parallel to the axis X12 to X15: to ensure the integrity of the housing 10 in the assembled state of the valve 1, the plastic weld W2 to W5 associated with the corresponding end 12 to 15 is designed, notably by virtue of its dimensions, to withstand these stresses applied by the elastic member 22.2 to 25.2 to the corresponding end 12 to 15.

The sealing member 22.3 to 25.3 of each of the seat devices 22 to 25 is mounted to be applied in a sealed manner all around the corresponding axis X12 to X15 against an inner periphery of the tubular skirt 12.1 to 15.1 of the corresponding end 12 to 15. To this end, in the assembled state of the valve 1, the elastic member 22.2 to 25.2 deforms the sealing member 22.3 to 25.3 to constrain the latter to be applied in a sealed manner against the inner periphery of the corresponding tubular skirt 12.1 to 15.1. In practice, the corresponding positioning ring 22.4 to 25.4 allows the deformation constraint applied to the sealing member 22.3 to 25.3 to be controlled by the elastic member 22.2 to 25.2, this positioning ring 22.4 to 25.4 being mounted in abutment, along the corresponding axis X12 to X15, against the corresponding support member 22.1 to 25.1, as particularly visible in FIG. 6 for the seat device 22. In the embodiment considered in the figures, the sealing member 22.3 to 25.3 advantageously has a generally annular shape, which is centered on the corresponding axis X12 to X15.

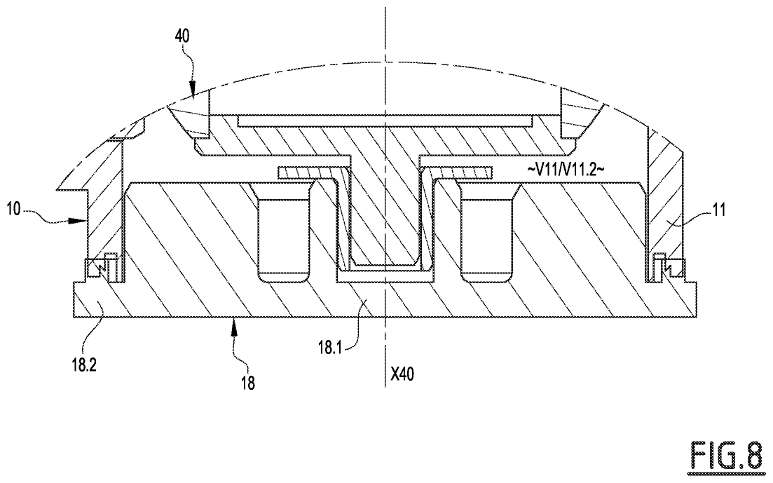

Following an optional advantageous arrangement, which is implemented in the embodiment illustrated in the figures, the shutter 40 is guided in movement relative to the housing 10, here in rotation around the shutter axis X40, by a cap 18 of the housing 10. This cap 18 closes the internal volume V11, here the sub-volume V11.2, by closing an opening O18 of the body 11 of the housing 10 in a sealed manner. Like the openings O11 to O15, the opening O18 directly connects the sub-volume V11.2 to the outside of the body 11 and is typically formed by molding-demolding of the body 11. The opening O18 has the specificity of being provided for the purpose of mounting the shutter 40 inside the volume V11, more precisely of the sub-volume V11.2. As particularly visible in FIG. 8, the cap 18 includes a solid wall 18.1, which, in the assembled state of the valve 1, completely covers the opening O18, being arranged here perpendicularly to the shutter axis X40, and which, at the outer periphery, is extended by a rim 18.2. This rim 18.2 is made of plastic material, in particular the same plastic material as that constituting the body 11. The rim 18.2 is welded to the body 11, more precisely to the external face of the wall of the latter, surrounding the opening O18. The considerations developed above regarding the plastic welding between the ends 12 to 15 and the body 11 advantageously apply to the welding between the rim 18.2 of the cap 18 and the body 11, to ensure a fixed and sealed assembly of the cap 18 to the body 11.

In any case, to control the movement of the shutter 40 and thus control the opening and closing of the outlets 10.2 to 10.5 of the housing 10, the valve 1 includes an actuation device 50. This actuation device 50 is electromechanical in the sense that this actuation device is designed to transform the electrical energy supplying it into a mechanical driving force, applied to the shutter 40 to drive the latter relative to the housing 10, here in rotation around the shutter axis X40.

In the assembled state of the valve 1, the actuation device 50 is carried by the housing 10, being at least partially housed in the compartment V17. In the embodiment considered in the figures, the actuation device 50 includes an electric motor 51 and a mechanical transmission 52, which connects a motor output 53 of the electric motor 51 to the shutter 40.

The electric motor 51 typically comprises a casing 54 inside which are arranged electromechanical components of the electric motor 51, which transform electrical energy into driving force, the motor output 53 extending through the casing 54. The casing 54 is fixedly attached to the housing 10, particularly its body 11, by any appropriate means, notably in a dedicated housing of the latter, advantageously belonging to the compartment V17, as schematically indicated in FIG. 1. Here, the motor output 53 rotates around a motor axis X51 relative to the housing 10, the mechanical transmission 52 being designed so that a rotation of the motor output 53 around the motor axis 51 drives the shutter 40, here in rotation around the shutter axis X40.

In the example considered in the figures, the mechanical transmission 52 includes a gear 55 consisting here of several gear wheels meshing successively with each other, a first of these wheels is engaged with the motor output 53 while the last of these gear wheels is engaged with the shutter 40, here with an axial end of its tubular body 41. This gear 55, whose specifics are not limiting, allows the movement transmitted from the motor output 53 to the shutter 40 to be multiplied. Of course, other embodiments than the gear 55 are conceivable for the mechanical transmission 52, notably depending on the kinematics of the motor output 53 and the kinematics of the shutter 40. In any case, as clearly visible in FIGS. 3 to 5, the motor output 53 and the mechanical transmission 52 are advantageously arranged in the compartment V17.

The actuation device 50, particularly its electric motor 51, and the pump 30, particularly its electronic part 35, are electrically connected, inside the compartment V17, to respective connectors or, as here, to a single connector 19, this or these connectors being carried by the housing 10. In the example illustrated in the figures, the single connector 19 is fixedly attached to the cover 17 in a sealed manner, and this is achieved by any appropriate means. In any case, the connector or connectors are designed to, outside the valve 1, each be connected to an added harness (not shown) to electrically connect the valve 1 to one or more external units, which are not shown, and which include a power supply source. This power supply source, whose embodiment is not limiting, comprises for example a battery that is embedded in the vehicle to the cooling circuit to which the valve 1 belongs. According to a possible embodiment, the aforementioned external units include one or more control and/or supervision units, such as an onboard computer of the vehicle to the cooling circuit to which the valve 1 belongs: the control and/or supervision unit or one of these control and/or supervision units is advantageously designed to control the electric motor 51, by sending to the latter ad hoc control electrical signals, via the added harness. According to another possible embodiment, the control of the electric motor 51 is operated by an electronic device, which belongs to the valve 1 and which is housed in the compartment V17, being notably integrated into the electrical connection between the connector 19 and the electric motor 51: this electronic device, which is not shown in the figures, can be either partially coupled to the electronic part 35 of the pump 30 or completely separate from the latter, in any case being suitable for sending to the electric motor 51 control and, if necessary, power supply electrical signals.

Finally, various arrangements and variants to the valve 1 described so far are also conceivable:
rather than integrating the pump 30 into the valve 1, this pump can be separated from it; this means that the valve then does not include the pump 30 and that the internal volume V11 can be limited to the sub-volume V11.2, with a corresponding adaptation of the body 11 of the housing 10 and a hose connection of the discharge of the remote pump with the inlet of the valve housing;
the number of outlets of the housing 10 is not necessarily equal to four, as considered in the figures, but can, for example, be limited to two or three or be equal to a number greater than four; and/or
the relative arrangement between the shutter axis X40 and the motor axis X51 is not limited to what is considered in the figures on which these two axes are parallel, the motor axis X51 can thus extend transversely to the shutter axis X40, notably perpendicularly or orthogonally to this shutter axis X40.

This valve (1) includes a housing (10) that includes a body (11) in plastic material defining an internal volume (V11) connected to the outside of the housing by an inlet and outlets (10.2, 10.3), at least one of the outlets including an end (12, 13). An electric pump (30), whose intake is connected to the inlet, is arranged in a first sub-volume (V11.1) of the internal volume. A discharge (33) of the pump opens into a passage (V11.3) of the internal volume, connecting the first sub-volume to a second sub-volume (V11.2). The body defines an opening (O11) connecting the second sub-volume to the outside of the body. A plug (16), fixedly assembled to the body, seals the opening in a fluid-tight manner. A shutter (40) is arranged in the second sub-volume in a movable manner by an electromechanical actuation device to control the opening and closing of the outlets. A seat device (22, 23) carried by the housing (10) is interposed along a seat axis between each end and the shutter in such a way as to let the fluid flow from the internal volume to the end when the shutter control the associated outlet in the open position, while preventing the fluid from reaching the end when the shutter controls this outlet in the closed position. Each seat device includes a support member, moving along the seat axis and cooperating by sliding sealing contact with the shutter, and an elastic member taking support against the end in such a way as to keep the support member applied axially against the shutter. Each end is assembled to the body in a fixed and sealed manner by welding between the body and a plastic part of the end, forming a plastic weld withstanding the stresses applied by the elastic member.

1. A fluid-dispensing motorized valve, including:
a housing that includes a body made of plastic material and defining an internal volume through which a fluid passes through the housing, this internal volume being connected to an outside of the housing by an inlet of the housing, through which the fluid enters the internal volume, and by outlets of the housing, through which the fluid exits the internal volume, at least one of the outlets including an end which is assembled to the body in a fixed and sealed manner,
an electric pump, which is arranged in a first sub-volume of the internal volume and which is provided with an intake, opening into the inlet of the housing, and a discharge, opening into a passage of the internal volume, which passage connects the first sub-volume to a second sub-volume of the internal volume by opening into this second sub-volume along a passage axis, the body defining an opening, through which the second sub-volume is directly connected to the outside of the body and which is formed by molding-demolding of the body, being aligned with the passage along the passage axis,
a plug, which seals the opening in a fluid-tight manner with respect to the fluid and which is assembled to the body in a fixed and sealed manner by welding between the body and a plastic part of the plug,
a shutter, which is arranged in the second sub-volume of the internal volume in a movable manner relative to the body of the housing (10) to control the opening and closing of the outlets of the housing,
an electromechanical actuation device, which is carried by the housing, and which is suitable for driving the shutter in movement relative to the body of the housing, and
for the or each end a seat device which is carried by the housing , being interposed along a seat axis between the end and the shutter in such a way as to (i) let fluid flow through the seat device from the internal volume to the end when the shutter controls the outlet associated with the seat device in an open position and (ii) prevent the fluid from reaching the end from the internal volume through the seat device when the shutter controls the outlet associated with the seat device in the closed position,
wherein the or each seat device includes:
a support member which moves along the seat axis relative to an corresponding end and which cooperates by sliding sealing contact with the shutter during the movement of the shutter relative to the body of the housing, and
an elastic member which takes support against the corresponding end in such a way as to, during the movement of the shutter relative to the body of the housing, keep the support member applied against the shutter along the corresponding seat axis,
and wherein the or each end is assembled to the body in a fixed and sealed manner by welding between the body and a plastic part of the end, forming a plastic weld that withstands stresses applied to the end by the elastic member of the corresponding seat device.

2. The valve according to claim 1, wherein, for the or each end the plastic weld runs continuously all around the corresponding seat axis.

3. The valve according to claim 1, wherein the or each end includes:
a tubular skirt, which extends in length along the corresponding seat axis, being substantially centered on this seat axis, which is received along the seat axis in a complementary opening of the body of the housing, and which internally receives the corresponding seat device, and
a peripheral rim which externally surrounds the tubular skirt, and which constitutes said plastic part of the end.

4. The valve according to claim 3, wherein the tubular skirt of the or each end includes an internal shoulder against which the corresponding elastic member is supported along the corresponding seat axis.

5. The valve according to claim 3, wherein, for the or each end the seat device further includes a sealing member, which is interposed along the corresponding seat axis between the corresponding support member and the corresponding elastic member, and which is applied in a sealed manner all around the corresponding seat axis against an inner periphery of the tubular skirt of the end.

6. The valve according to claim 1, wherein the or each end includes a part for connection to a conduit, such as a hose.

7. The valve according to claim 1, wherein the shutter moves relative to the body of the housing in rotation around a shutter axis relative to which the seat axis of the or each seat device extends transversely.

8. The valve according to claim 7, wherein the shutter includes at least one spherical relief, which is centered on the shutter axis, and which cooperates by complementarity of shapes with the support member of the or one of the seat devices.

9. The valve according to claim 1, wherein the housing further includes a cap, which closes the internal volume and which guides the movement of the shutter relative to the body, being assembled to the body in a fixed and sealed manner by welding to the body of a plastic part of the cap.

10. The valve according to claim 6, wherein the conduit is a hose.
